(19) United States
(12) Patent Application Publication
(10) Pub. No.: US 2008/0101791 A1
(43) Pub. Date: May 1, 2008

(54) SHUTTER AND CAMERA MODULE WITH SAME

(75) Inventor: BOR-YUAN HSIAO, Tu-Cheng (TW)

Correspondence Address: PCE INDUSTRY, INC.;ATT. CHENG-JU CHIANG J, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/737,095

(22) Filed: Apr. 18, 2007

(30) Foreign Application Priority Data
Oct. 27, 2006 (CN) 200610201038.0

(51) Int. Cl. G02B 26/02; G03B 9/08

(52) U.S. Cl. 396/457; 359/228; 977/773

(57) ABSTRACT

An exemplary shutter includes a chamber; a transparent, hydrophobic dielectric layer; a light-tight (i.e., non-transparent), insulating oily layer; a transparent conductive aqueous layer; and a pair of electrodes. The chamber has a pair of opposing transparent plates. The dielectric layer, the oily layer, and the aqueous layer are accommodated in the chamber, in that order, from one of the pair of transparent plates to the other. The pair of the electrodes is configured for generating an electric field to induce an electrowetting effect in the aqueous layer.

### BACKGROUND

1. Technical Field

The present invention relates to image technology and, particularly, relates to a shutter and a camera module having the same.

2. Description of Related Art

Shutters controls the exposure time of light-sensitive members (i.e., photographic films or electronic image sensors) in cameras. A quality shutter should have an excellent light-switching effect and a fast response time.

Most shutters are mechanical, in nature, and include a complex arrangement of blades, gears, springs, and/or motors. Thus, these mechanical shutters tend to be bulky. Additionally, mechanical shutters can be highly energy consuming (thus promoting quick battery drain) and noisy. Accordingly, cameras equipped with mechanical shutters often are bulky and noisy and have a high power consumption.

Therefore, it is desirable to provide a shutter and a camera module, which can overcome the above mentioned problems.

### SUMMARY

In a preferred embodiment, a shutter includes a chamber, a transparent hydrophobic dielectric layer, a non-transparent, insulating oily layer, a transparent conductive aqueous layer, and a pair of electrodes. The chamber has a pair of opposing transparent plates. The dielectric layer, the oily layer, and the aqueous layer are accommodated in the chamber, in this order, from one of the pair of transparent plates to the other. The pair of the electrodes is configured for generating an electric field to induce an electrowetting effect in the aqueous layer.

### BRIEF DESCRIPTION OF THE DRAWINGS

Many aspects of the present shutter and camera module should be better understood with reference to the following drawings. The components in the drawings are not necessarily drawn to scale, the emphasis instead being placed upon clearly illustrating the principles of the present shutter and camera module. Moreover, in the drawings, like reference numerals designate corresponding parts throughout the several views.

FIG. 1 is a schematic, isometric view of a shutter, according to a first preferred embodiment;

FIG. 2 is a cross-sectional view taken along line II-II of FIG. 1;

FIG. 3 is a schematic, cross-sectional view of a shutter, showing an electrowetting effect;

FIG. 4 is a schematic, cross-sectional view of a camera module, employing the shutter of the first preferred embodiment;

FIG. 5 is a schematic, cross-sectional view of another shutter, according to a second preferred embodiment; and

FIG. 6 is a schematic, cross-sectional view of another shutter, according to a third preferred embodiment.

### DETAILED DESCRIPTION OF THE EMBODIMENTS

Embodiments will now be described in detail with reference to the drawings.

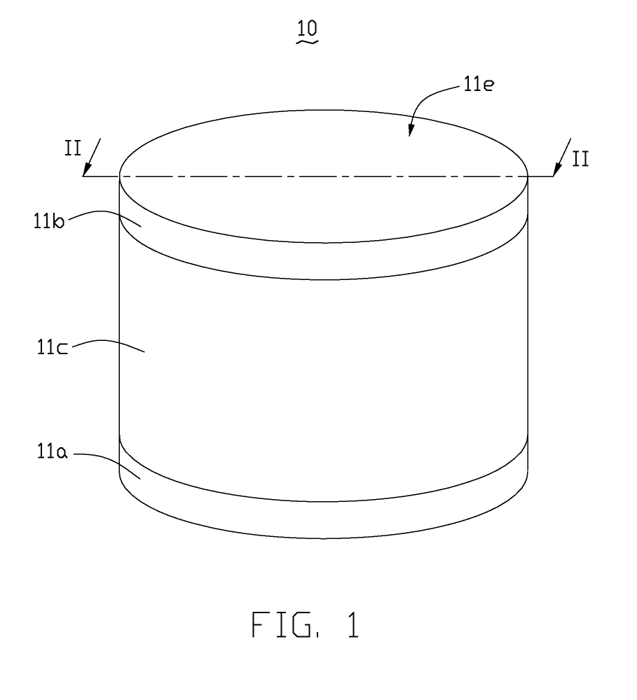

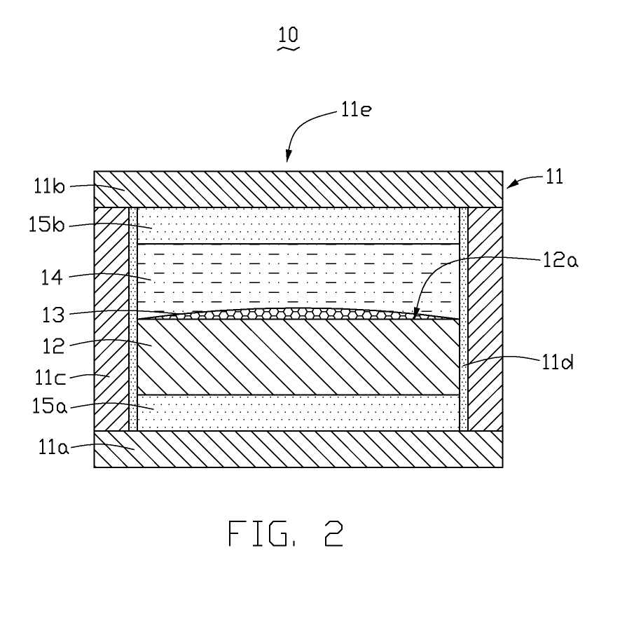

Referring to FIG. 1 and FIG. 2, a shutter 10, according to a first preferred embodiment, includes a chamber 11, a transparent hydrophobic dielectric layer 12, a non-transparent, insulating oily layer 13, a transparent conductive aqueous layer 14, and a pair of electrodes 15a, 15b. The chamber 11 includes a pair of opposing transparent plates 11a, 11b. The dielectric layer 12, the oily layer 13, and the aqueous layer 14 are accommodated in the chamber 11, in this order, from a first transparent plate 11a to a second transparent plate 11b. The pair of the electrodes 15a, 15b is configured for generating an electric field to induce an electrowetting effect in the aqueous layer.

The chamber 11 is, advantageously, cylindrical in shape (see FIG. 1). The pair of opposing transparent plates 11a, 11b is at the two end of the chamber 11, i.e., cylindrical chamber. In addition to the pair of opposing transparent plates 11a, 11b, the chamber 11 further includes a light-tight (i.e., non-transparent) sidewall 11c joined between the pair of transparent plates 11a, 11b. In particular, such transparent plates 11a, 11b, respectively, are directly attached (e.g., via an adhesive) to opposing ends of the sidewall 11c. The sidewall 11c defines therethrough a light passage 11e in the shutter 10 to guide light transmitting from one of the pair of transparent plates 11a, 11b to the other. In this embodiment, the respective transparent plates 11a, 11b are parallel to each other, and the sidewall 11c is hermetically sealed to the pair of parallel transparent plates 11a, 11b. The pair of transparent plates 11a, 11b can be made from materials such as transparent glass, transparent plastic, or transparent ceramic. The sidewall 11c can be made from materials such as light-tight glass, light-tight plastic, or light-tight ceramic. Preferably, the inner surface of the sidewall 11c is coated with a light-reflective film 11d to enhance the light-tight effect of the sidewall 11c. Alternatively, the light-reflective film 11d can be coated on the outer surface of the sidewall 11c. The chamber 11, usefully, has a diameter and height both of less than 10 micrometers, thereby keeping the size of the shutter 1 0 relative small.

The dielectric layer 12 is disposed between the pair of electrodes 15a, 15b. The dielectric layer 12 may, e.g., be formed by any of various techniques, such as chemical vapor deposition (CVD) or sputtering. The dielectric layer 12 is, beneficially, made of dielectric materials that are transparent and hydrophobic, e.g., silicon dioxide, polycarbonate, or olefin.

The oily layer 13 and the aqueous layer 14 are not soluble with each other. As the dielectric layer 12 has a low surface energy with respect to water (i.e., hydrophobic), the oily layer 13 naturally forms a film over the entire hydrophobic surface 12a of the dielectric layer 12. Thus, light transmitting through the light passage 11e is totally blocked by the oily layer 13. Thus, the shutter 10 is closed. In addition, the oily material of the oily layer 13 and the aqueous material of the aqueous layer 14 are, usefully, density-matched to prevent gravity or vibration from influencing the operation of the shutter 10.

The oily layer 13 is advantageously made of a black, insulating, and oily material, for example, carbon black insulating oil or silicon black insulating oil. Preferably, the oily layer 13 is doped with metal nano-particles (not shown), such as copper or iron nano-particles. Copper and/or iron turn black (i.e., exhibits a black color) and become insulative at the nano-level. Thus, these metallic nano-particles can enhance the light-tight effect of the oily layer 13.

The aqueous layer 14 is a weak brine solution. The brine could be, e.g., sodium chloride solution, potassium chloride solution, sodium sulfate solution, and/or calcium chloride solution.

The electrodes 15a, 15b are electrically insulated from each other by the dielectric layer 12, and one of the electrodes 15a, 15b is electrically connected/coupled with the aqueous layer 14. In the illustrated embodiment, each of the electrodes 15a, 15b is a transparent thin-film electrode. A first electrode 15a is disposed directly on the first transparent plate 11a, and a second electrode 15b is disposed directly on the second transparent plate 11b and is in contact with the aqueous layer 14. In other words, the pair of electrodes 15a, 15b is respectively deposited on opposing/facing surfaces of the pair of transparent plates 11a, 11b. The pair of electrodes 15a, 15b is made of a transparent conductive material, e.g., Indium-Tin Oxide.

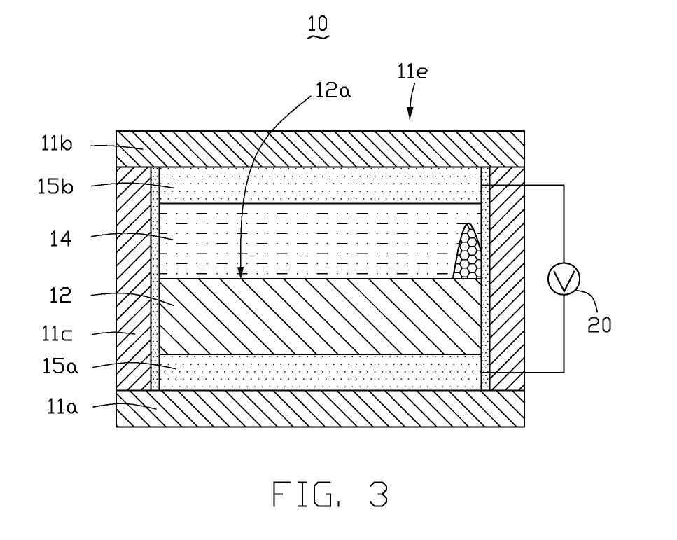

FIG. 3 illustrates an electrowetting effect generated in the shutter 10, when a voltage is applied thereto. When a voltage source 20 is electrically connected to the first thin-film electrode 15a and the second thin-film electrode 15b, an electric field is generated therebetween, and the dielectric layer 12 is polarized by the electric field. The hydrophobic surface 12a gathers electric charges with an electric charge property opposite to that of the second thin-film electrode 15b. As the aqueous layer 14 is electrically connected to the thin-film second electrode 15b, the aqueous layer 14 has an electric charge property similar to that of the second thin-film electrode 15b. Thus, an electric attracting force is generated between the hydrophobic surface 12a and the aqueous layer 14 and drives the aqueous layer 14 to wet the hydrophobic surface 12a. Accordingly, the oily layer 13 is displaced to a fraction of its original area. Light can transmit through the light passage 11e with low attenuation through the areas where the aqueous layer 14 contacts the hydrophobic surface 12a. Therefore, the shutter 10 is opened.

When the voltage source 20 is shut off or disconnected from the first thin-film electrode 15a and the second thin-film electrode 15b, the electric attracting force generated by the electric field vanishes. The oily layer 13 and the aqueous layer 14 return to their original status (i.e., the oily layer 13 extending across the diameter of the chamber 11), as shown in the FIG. 2. The shutter 10 is closed again.

The displacement of the oily layer 13 is governed by an electrostatic term 0.5CV2, where C is the capacitance of the pair of thin-film electrodes 15a, 15b, and V is the voltage applied to the pair of electrodes 15a, 15b. The oily layer 13 can be displaced to less than 20% of its original area by modulating the electrostatic field. Namely, light transmission of the shutter 10 can reach more than 80% when the shutter 10 is in an opened state. On the other hand, when the shutter 10 is in a closed state, light transmission of the shutter 10 is 0%. Namely, the shutter 10 has an excellent light-switch effect. In addition, the shutter 10 is devoid of blades, gears, springs, and/or motors, and the chamber 11 can be reduced to micrometer size or smaller. Thus, the shutter 10 can be manufactured at a small-sized scale. Further, the wetting movement of the aqueous layer 14 is a kind of microfluidic movement characterized with low power consumption (less than 15V DC) and fast response time (10 microseconds). Moreover, microfluidic movement can operate relatively quietly. Resulting in a quality shutter, that is small in size, has low power-consumption, and is quiet.

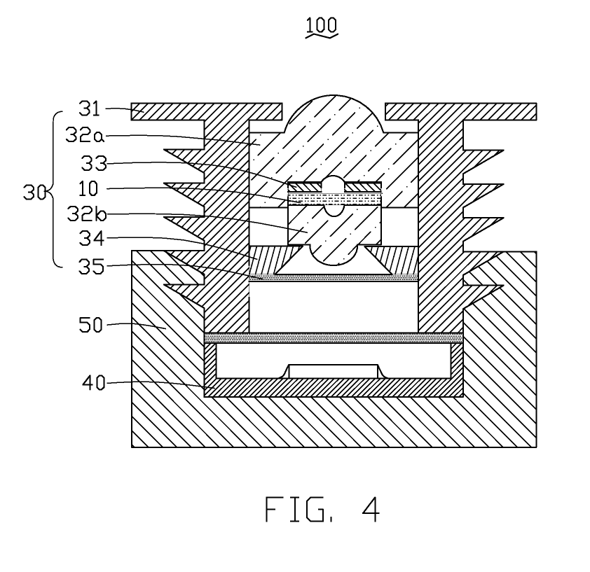

Referring to FIG. 4, a camera module 100 employing the shutter 10 is shown. The camera module 100 includes a lens module 30 and a light-receiving (i.e., imaging) member 40 disposed in an image field of the lens module 30. The lens module 30 includes a lens barrel 31, and the shutter 10 is received in the lens barrel 30.

In the illustrated embodiment, the camera module 100 further includes a holder 50. The lens module 30 further includes two aspheric lenses 32a, 32b, a diaphragm 33, a spacer 34, and an infrared (IR) color filter 35. The light-receiving member 40 is disposed in the holder 50. The lens barrel 31 is coupled with the holder 50 using threads. The first lens 32a, the diaphragm 33, the shutter 10, the second lens 32b, the spacer 34, and the IR color filter 35 are all received in the lens barrel 31, in this order, from the object side to the image side of the lens module 30. Alternatively, the lens module 30 can employ just one lens to reduce the cost or can employ more than two lenses to improve the image quality produced by the lens module 100.

The light-receiving member 40 can be a photographic film, a charge-coupled device (CCD), or a complementary metal oxide semiconductor (CMOS) device.

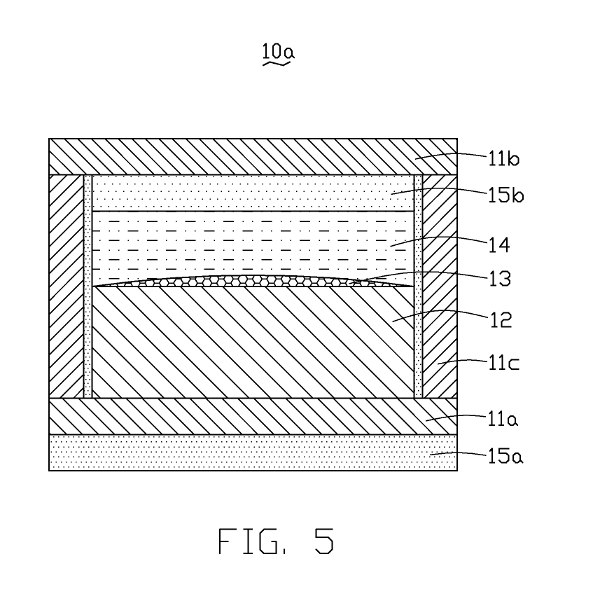

Referring to FIG. 5, another shutter 10a according to a second preferred embodiment is shown. The shutter 10a is essentially similar to the shutter 10 except with respect to the position of the first thin-film electrode 15a. In this embodiment, the first electrode 15a is disposed on the outer surface of the plate 11a. In this embodiment, when a voltage is applied to the first electrode 15a and the second electrode 15b, an electric field is generated therebetween and electrowetting effect is induced similar to the first preferred embodiment.

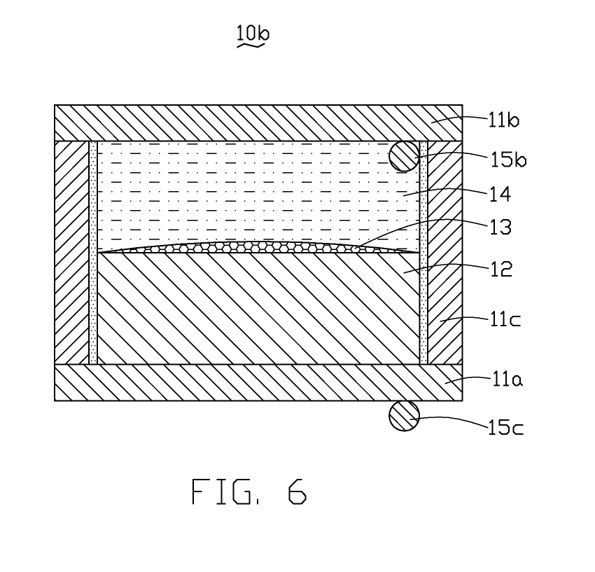

Referring to FIG. 6, another shutter 10b according to a third preferred embodiment is shown. The shutter 10b is essentially similar to the shutter 10a except with respect to the shape and material of the pair of electrodes. In this embodiment, the pair of electrode 15c, 15d are ball shaped. Each ball electrode 15c, 15d beneficially has a diameter less than 40% of the inner diameter of the chamber 11. Also, the pair of ball electrodes 15c, 15d can be made of a light-tight conductive material, such as, copper or silver, wherein it will block the light passing through the light passage 11e no more than 16%, due to the size and shape thereof. Thus, the shutter 10b still has a light transmission more than 80%. In this embodiment, the pair of ball embodiment may be made of any (including transparent and light-tight) electrically conductive material.

It will be understood that the above particular embodiments and methods are shown and described by way of illustration only. The principles and the features of the present invention may be employed in various and numerous embodiment thereof without departing from the scope of the invention as claimed. The above-described embodiments illustrate the scope of the invention but do not restrict the scope of the invention.

What is claimed is:

1. A shutter comprising:
a chamber including a pair of opposing transparent plates;
a transparent hydrophobic dielectric layer;
a non-transparent, insulating oily layer;
a transparent conductive aqueous layer, the dielectric layer, the oily layer and the aqueous layer being accommodated in the chamber, in order, from one of the pair of transparent plates to the other; and
a pair of electrodes configured for generating an electric field to induce an electrowetting effect in the aqueous layer.

2. The shutter as claimed in claim 1, wherein the chamber further comprises a non-transparent sidewall joined between the pair of transparent plates.

3. The shutter as claimed in the claim 2, wherein the sidewall is coated with a light-reflective film.

4. The shutter as claimed in the claim 1, wherein the chamber has a diameter and height both of less than 10 micrometers.

5. The shutter as claimed in the claim 1, wherein the dielectric layer is comprised of a transparent and hydrophobic material.

6. The shutter as claimed in the claim 1, wherein the oily layer is comprised of non-transparent and insulating material comprised of at least one material selected from the group consisting of carbon black insulating oil and silicon black insulating oil.

7. The shutter as claimed in the claim 1, wherein the oily layer is doped with metal nano-particles.

8. The shutter as claimed in the claim 7, wherein the nano-particles are comprised of at least one metal material selected from the group consisting of copper and iron.

9. The shutter as claimed in the claim 1, wherein the aqueous layer is a transparent weak brine solution.

10. The shutter as claimed in the claim 9, wherein the brine solution includes at least one solution selected from a group consisting of: sodium chloride solution, potassium chloride solution, sodium sulfate solution and calcium chloride solution.

11. The shutter as claimed in claim 1, wherein the electrodes are electrically insulated from each other by the dielectric layer, one of the electrodes being electrically coupled with the aqueous layer.

12. The shutter as claimed in the claim 11, wherein each electrode is a transparent thin-film electrode, the pair of thin-film electrodes being respectively deposited on opposing surfaces of the pair of transparent plates.

13. The shutter as claimed in the claim 11, wherein each thin-film electrode is made of Indium-Tin Oxide.

14. The shutter as claimed in the claim 11, wherein each electrode is a transparent thin-film electrode, each thin-film electrode being respectively deposited on one of the pair of transparent plates, the thin-film electrode electrically coupled with the aqueous layer being deposited on the inner surface of the chamber, the other thin-film electrode being deposited on the outer surface of the chamber.

15. The shutter as claimed in the claim 11, wherein each electrode is ball shaped, each ball electrode being respectively attached to a corresponding one of the pair of transparent plates.

16. The shutter as claimed in the claim 16, wherein each ball electrode has a diameter of less than 40% of an inner diameter of the chamber.

17. The shutter as claimed in the claim 1, wherein a voltage source is connected to the pair of electrodes.

18. A camera module comprising:
a lens module; and
a light-receiving member aligned in an image space of the lens module;
wherein the lens module comprises:
a lens barrel; and
a shutter received in the lens barrel comprising:
a chamber including a pair of opposing transparent plates;
a transparent hydrophobic dielectric layer;
a non-transparent, insulating oily layer;
a transparent conductive aqueous layer, the dielectric layer, the oily layer, and the aqueous layer being accommodated in the chamber, in order, from one of the pair of transparent plates to the other; and
a pair of electrodes configured for generating an electric field to induce an electrowetting effect in the aqueous layer.
